(19) United States
(12) Patent Application Publication
(10) Pub. No.: US 2020/0111438 A1
(43) Pub. Date: Apr. 9, 2020

(54) DISPLAY DRIVING METHOD AND DEVICE, DISPLAY DEVICE

(71) Applicants: HKC Corporation Limited, Shenzhen (CN); Chongqing HKC Optoelectronics Technology Co., Ltd., Chongqing (CN)

(72) Inventor: Mingliang Wang, Shenzhen (CN)

(21) Appl. No.: 16/257,084

(22) Filed: Jan. 25, 2019

Related U.S. Application Data
(63) Continuation of application No. PCT/CN2018/115295, filed on Nov. 14, 2018.

(30) Foreign Application Priority Data
Oct. 8, 2018 (CN) 201811170769.2

(51) Int. Cl. G09G 3/36

(52) U.S. Cl. CPC G09G 3/3688; G09G 3/3614; G09G 2320/0633; G09G 2320/0276; G09G 2320/0233

(57) ABSTRACT

The present application discloses a display driving method and device, and a display device. The display driving method outputs a first data signal to a display pixel scanned to the near end and a second data signal to a display pixel scanned to the far end when the display pixel is scanned and driven.

### CROSS REFERENCE TO RELATED APPLICATIONS

The present application is a Continuation Application of PCT Application No. PCT/CN2018/115295 filed on Nov. 14, 2018, which claims the benefit of Chinese Patent Application No. 201811170769.2 filed on Oct. 8, 2018. All the above are hereby incorporated by reference.

### FIELD

The present application relates to the field of display technologies, in particular, to a display driving method and device, and a display device.

### BACKGROUND

Display devices, such as TFT-LCD (Thin Film Transistor Liquid Crystal Display), have become an indispensable product in modern IT and video products.

However, with the large size and high resolution requirements for the display device, the existing data driving method cannot guarantee the display effect and needs to be improved.

### SUMMARY

Embodiments of the present application solves the technical problem that the charging effect of all display pixels of the display device may not be guaranteed in the display driving process in the prior art by providing a display driving method and device, and a display device.

Embodiments of the present application provide a display driving method comprising steps of:

periodically outputting a row driving signal to drive display pixels of each row;

obtaining a position of a row driven by the current row driving signal, and determining whether a row driven by the current row driving signal is located at a near end or a far end;

outputting a first data signal if the row driven by the current row driving signal is located at the near end; and,

outputting a second data signal if the row driven by the current row driving signal is located at the far end;

wherein among the display pixels of all the rows, the display pixel away from a signal output source of the row driving signal with a predetermined number of rows is the near-end, and the display pixel of the remaining rows is the far end.

Optionally, the display driving method further comprises:

counting each time a row of display pixels is driven to obtain a position of a row driven by the current row driving signal according to the counting result.

Optionally, when the row driving signal is sequentially provided row by row, the step of obtaining a position of a row driven by the current row driving signal includes:

determining that the row driven by the current row driving signal is located at the far end when the count value is greater than a predetermined number of rows; determining that the row driven by the current row driving signal is located at the near end when the count value is less than or equal to the predetermined number of rows.

Optionally, when the row driving signal is provided row by row in reverse order, the step of obtaining a position of a row driven by the current row driving signal includes:

determining that the row of the signal driven by the current row driving signal is located at the near end when the count value is greater than a predetermined number of rows; determining that the row of the signal driven by the current row driving signal is located at the far end when the count value is less than or equal to the predetermined number of rows.

Optionally, the predetermined number of rows is configured according to a predetermined ratio of the number of rows of all display pixels.

Optionally, the predetermined ratio is 50%.

Optionally, the amplitude of the first data signal is less than the amplitude of the second data signal.

Embodiments of the present application further provide a display driving device comprising:

a row driving module periodically outputting a row driving signal to drive display pixels of each row;

a driving controller outputting a driving control signal, controlling the row driving module to perform scanning, and obtaining a position of a row driven by the current row driving signal, and determining whether a row driven by the current row driving signal is located at a near end or a far end;

a data driving module generating a first data signal when the row driven by the current row driving signal is located at a near end, and outputting a second data signal when the row driven by the current row driving signal is located at a far end, according to the position determination result of the driving controller;

wherein among the display pixels of all the rows, the display pixel away from a signal output source of the row driving signal with a predetermined number of rows is the near-end, and the display pixel of the remaining rows is the far end.

Optionally, the driving controller includes a counter and a processor, counting once each time the row driving module completes driving of one row of display pixels; the processor determines a position of a row driven by the current row driving signal according to the counting result, and generates a corresponding driving control signal to control the data driving module to output a corresponding data signal.

Optionally, the driving control signal is a one-bit status code.

Optionally, the data driving module includes:

a gamma voltage generating unit generating a first gamma signal when the row driven by the current row driving signal is located at a near end, and generating a second gamma signal when the row driven by the current row driving signal is located at a far end;

a data driving unit outputting a corresponding data signal according to the gamma signal generated by the gamma voltage generating unit.

Optionally, the amplitude of the first data signal is less than the amplitude of the second data signal.

Optionally, when the processor sequentially provides a driving signal row by row to drive the display pixel row by row, the processor determines, according to the count result of the counter, that when the count value is greater than a predetermined number of rows, the row driven by the current row driving signal is located at the far end, otherwise determines that the row driven by the current row driving signal is located at the near end.

Optionally, when the processor provides a driving signal row by row to drive the display pixel row by row in reverse order, the processor determines, according to the count result of the counter, that when the count value is less than or equal to a predetermined number of rows, the row driven by the current row driving signal is located at the far end, otherwise determines that the row driven by the current row driving signal is located at the near end.

Optionally, the predetermined number of rows is configured according to a predetermined ratio of the number of rows of all display pixels.

Optionally, the predetermined ratio is 50%.

Embodiments of the present application further provide a display device comprising:

a display pixel and a display driving device that drives the display pixel to illuminate, the display driving device including:

a row driving module periodically outputting a row driving signal to drive display pixels of each row;

a driving controller outputting a driving control signal, controlling the row driving module to perform scanning, and obtaining a position of a row driven by the current row driving signal, and determining whether a row driven by the current row driving signal is located at a near end or a far end;

a data driving module generating a first data signal when the row driven by the current row driving signal is located at a near end, and outputting a second data signal when the row driven by the current row driving signal is located at a far end, according to the position determination result of the driving controller;

wherein among the display pixels of all the rows, the display pixel away from a signal output source of the row driving signal with a predetermined number of rows is the near-end, and the display pixel of the remaining rows is the far end.

Optionally, the driving controller includes a counter and a processor, counting once each time the row driving module completes driving of one row of display pixels; the processor determines a position of a row driven by the current row driving signal according to the counting result, and generates a corresponding driving control signal to control the data driving module to output a corresponding data signal.

Optionally, the driving control signal is a one-bit status code.

Optionally, the data driving module includes:

a gamma voltage generating unit generating a first gamma signal when the row driven by the current row driving signal is located at a near end, and generating a second gamma signal when the row driven by the current row driving signal is located at a far end;

a data driving unit outputting a corresponding data signal according to the gamma signal generated by the gamma voltage generating unit.

Embodiments of the present application output different data signals according to the position of the row driven by the row driving signal, thereby improving the problem of the difference in the charging effect of the display pixels at the near end and far end, and achieving a uniform display effect.

### BRIEF DESCRIPTION OF THE DRAWINGS

FIG. 1 is a structural view of a display device according to an embodiment of the present application;

FIG. 2 is a flow chart of a method for display driving device according to an embodiment of the present application;

FIG. 3 is a view of functional modules of a display driving device according to an embodiment of the present application;

FIG. 4 is a view of functional modules of a display driving device according to another embodiment of the present application.

### DESCRIPTION OF THE REFERENCE NUMERALS

| | Reference | | Reference |
|---|---|---|---|
| Name | numeral | Name | numeral |
| substrate | 10 | Driving controller | 11 |
| Display region | 101 | Row driving module | 12 |
| Non-display region | 102 | Data driving module | 13 |
| Row position | 14 | Gamma voltage | 131 |
| acquisition module | | generating unit | |
| Data driving unit | 132 | | |

### DETAILED DESCRIPTION OF THE EMBODIMENTS

In order to better understand the above-described technical solutions, exemplary embodiments of the present disclosure will be described in more detail below with reference to the accompanying drawings. While the exemplary embodiments of the present disclosure are shown in the drawings, it should be understood that the present disclosure may be implemented in various forms and should not be limited by the embodiments set forth herein. Rather, these embodiments are provided so that this disclosure will be more fully understood, and the scope of the disclosure may be fully conveyed to those skilled in the art.

It should be noted that if the embodiments of the present application relates to directional indications (such as up, down, left, right, front, back, . . . ), they are only used to explain the relative positional relationship, motion situation and the like between components in a certain posture (as shown in the drawings), if the specific posture changes, the directional indication shall also change accordingly.

In addition, if the embodiments of the present application relates to the descriptions of “first”, “second” and the like, they are only used for the purpose of description only, and are not to be construed as indicating or implying their relative importance or implicitly indicating the number of technical features indicated. Thus, features defined with “first”, “second” may include at least one such feature, either explicitly or implicitly. In addition, the technical solutions between the various embodiments may be combined with each other, provided that those skilled in the art can implement it, and when the combination of the technical solutions is contradictory or impossible to implement, it should be considered that the combination of these technical solutions does not exist, nor is it within the scope of protection required by this application.

In order to solve the technical problem that the existing display driving solution may not meet the requirements of large size and high resolution of the display device, embodiments of the present application provide a new display driving solution, that is, in the display driving process, corresponding gamma signals are output according to different driving positions to ensure the charging effect of all display pixels of the display device, and uniform brightness of the display device.

In order to facilitate the understanding of the embodiments of the present application, before describing the specific embodiments of the present application, the driving principle of the display device constructed in an embodiment will be briefly described.

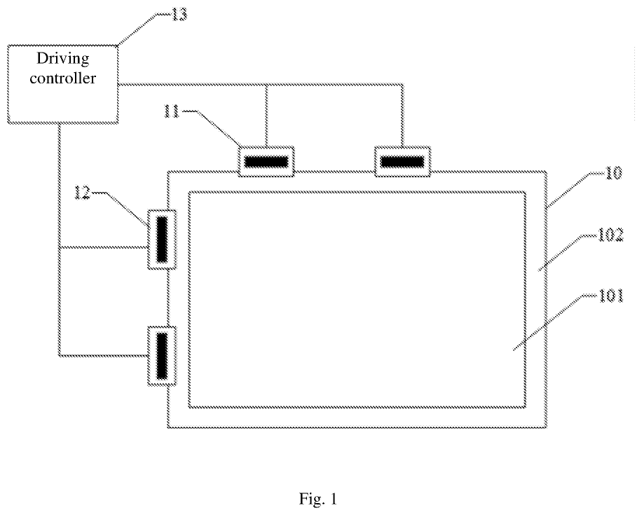

Referring to FIG. 1, FIG. 1 is a structural view of a display device according to an embodiment of the present application. The display device includes a substrate 10 and a display driving device 11. Specifically:

A display region 101 and a non-display region 102 are formed on the substrate 10; wherein the display region 101 includes a plurality of display pixels, and the plurality of display pixels may be in a matrix structure arranged in rows and columns, of course, not limited to a matrix arrangement structure, and may be other arrangements.

Further, the display region 101 is also formed with signal lines and switching devices arranged in a cross. The signal line may specifically include a first signal line and a second signal line electrically connected to the switching device. The switching device is configured to activate the switching device when receiving the first driving signal on the first signal line; at this time, the display pixel may receive the second driving signal from the second signal line through the activated switching device, and illuminate according to the second driving signal. Specifically, the above switching device may include, but is not limited to, a TFT (Thin Film Transistor), and may also include, for example, a field effect transistor, a triode, or the like. The first signal line and the second signal line described above may also be referred to as a scan line and a data line.

The display driving device may specifically include a driving controller 11, a row driving module 12, and a data driving module 13, wherein the driving controller 11 outputs a driving control signal to control the row driving module 12 and the data driving module 13 to output corresponding driving signals to drive the display pixels to operate. Specifically, the row driving module 12 outputs the driving signal row by row. If the display pixel of the current row receives the driving signal, the corresponding switching device starts to operate. The display pixel of the current line may receive the data signal output by the data driving module 13 through the activated switching device and illuminate according to the data signal. By analogy, after the display driving device completes the driving of all the row display pixels row by row, the update of one frame is completed. Since the display driving device outputs the driving signal row by row, when the display driving device outputs the driving signal to the display pixels far from the display driving device, the data signal output from the data driving module 13 may not satisfy the signal driving effect.

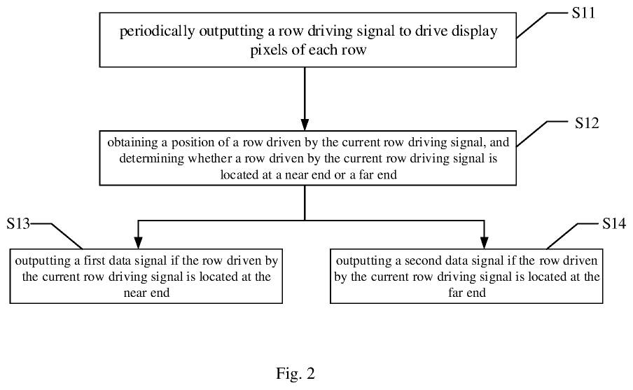

For this, referring to FIG. 2, FIG. 2 is a flow chart of a method for display driving device according to an embodiment of the present application. The technical solution of the present application provides a novel display driving method. In the display driving method, display pixels of all rows are divided into a display pixel at a near end and a display pixel at a far end, specifically, the display pixel away from the display driving device with a predetermined number of rows is the near-end, and the display pixel of the remaining rows is the far end. Further, the predetermined number of rows may be configured according to a predetermined ratio of the number of rows of all display pixels. The predetermined ratio is, for example, 1/2. For example, taking 1000 rows of display pixels as an example, calculating starts at the display pixel close to the display driving device, the display pixels of the first 500 rows are the display pixels of the near end, and the display pixels of the 501st row and subsequent pixels are the display pixels of the far end. In addition, the number of predetermined rows may also consider the charging effect. For example, if the designer finds that when driving until the display pixel of the 600th row, the display effect of the display pixel starts to deteriorate, so the predetermined number of rows may be set to 600.

Specifically, the above novel display driving method comprises steps of:

S11, periodically outputting a row driving signal to drive display pixels of each row;

S12, obtaining a position of a row driven by the current row driving signal, and determining whether a row driven by the current row driving signal is located at a near end or a far end;

S13, outputting a first data signal if the row driven by the current row driving signal is located at the near end; and,

S14, outputting a second data signal if the row driven by the current row driving signal is located at the far end.

When the row driving module 12 outputs the first driving signal to drive the display pixels of each row, the position of the current row of the driving is obtained, and whether the current row is located at the near end or at the far end is determined. The first data signal is output when the current row is located at the near end and the second data signal is output when the current row is located at the far end. Among them, the first data signal and the second data signal are, for example, signals having different amplitudes, specifically, the amplitude of the first data signal is less than the amplitude of the second data signal.

Embodiments of the present application output different data signals according to the position of the row driven by the row driving signal, thereby improving the problem of the difference in the charging effect of the display pixels at the near end and far end, and achieving a uniform display effect.

In a certain embodiment of the present application, in the above step S11, the row driving signals may be sequentially provided in a row-by-row or reverse-sequence, row-by-row or interlaced manner to drive the display pixels row by row or in interlaced manner. When the row driving signals are sequentially supplied row by row, the driving controller 11 controls the row driving module 12 to periodically output the first driving signal, and sequentially outputs to the first row display pixel, the second row display pixel, the third row display pixel, . . . , the nth row display pixel. When the row driving signals are supplied in reverse order, row by row, the driving controller 11 controls the row driving module 12 to periodically output the first driving signal, and sequentially outputs to the nth row display pixel, the n−1th row display pixel, the n−2th row display pixel, . . . , the first row display pixel. When the row driving signals are supplied in interlaced manner, the driving controller 11 controls the row driving module 12 to periodically output the second driving signal, and sequentially outputs to the first row display pixel, the third row display pixel, the fifth row display pixel, . . . , the n−1th row display pixel, and then outputs to the second row display pixel, the fourth row display pixel, . . . , the nth row display pixel.

In a certain embodiment of the present application, the position of the row driven by the above-described row driving signal may be realized by a counter. Specifically, counting is performed by configuring a counter for driving the display pixels each time one row is completed. According to the count value of the counter, the position of the row driven by the driving signal of the current row may be determined. In an embodiment of the present application, the counter technology is relatively simple, so it is easy to increase the structure of the counter in the display driving device; if the counter structure already exists in the display driving device, the original structure of the display driving device may also be utilized, thereby saving hardware costs.

Further, due to the different way of driving the row, there is also a difference in determining the position of the row driven by the current row driving signal according to the count value of the counter. The following description will be respectively made according to the row driving mode, which is a row-by-row driving and an interlaced driving mode.

When the processor controls the row driving module 12 to sequentially drive the display pixels row by row, a first predetermined threshold is determined. The first predetermined threshold is a predetermined number of rows when the near-end and far-end are determined. Step S12 specifically includes: determining that the row driven by the current row driving signal is located at the far end when the count value is greater than the first predetermined threshold; determining that the row driven by the current row driving signal is located at the near end when the count value is less than or equal to the first predetermined threshold.

Taking 1000 rows of display pixels as an example, it is assumed that the first to 500th rows of display pixels close to the data driving module 13 are used as the display pixels at the near end, and the remaining display pixels are used as the display pixels at the far end. Therefore, when the count value is greater than 500, it is determined that the current row driving signal has been driven to the display pixel at the far end; when the count value is less than or equal to 500, it is determined that the current row driving signal still drives the display pixels at the near end.

Similarly, when the processor controls the row driving module 12 to drive the display pixels in reverse order row by row, Step S12 specifically includes: determining that the row driven by the current row driving signal is located at the near end when the count value is greater than the first predetermined threshold; determining that the row driven by the current row driving signal is located at the far end when the count value is less than or equal to the first predetermined threshold.

When the processor controls the row driving module 12 to drive the display pixels in interlaced manner, a second predetermined threshold is determined. The second predetermined threshold is ½ of the predetermined number of rows when the near-end and far-end are determined. Step S12 specifically includes: determining that the row driven by the current row driving signal is located at the far end when the count value is within a predetermined range; determining that the row driven by the current row driving signal is located at the near end when the count value is outside the predetermined range.

Taking 1000 rows of display pixels as an example, it is assumed that the first to 500th rows of display pixels close to the data driving module 13 are used as the display pixels at the near end, and the remaining display pixels are used as the display pixels at the far end. Therefore, when the count value is between 250-500 and 750-1000, it is determined that the current row driving signal has been driven to the display pixel at the far end; when the count value is between 1-250 (not included) and 501-750 (not included), it is determined that the current row driving signal still drives the display pixels at the near end.

Based on the above embodiments, other embodiments of the present application may be modified. For example, the display pixels of all the rows are divided into three or more regions, and different data signals are output corresponding to the plurality of regions to ensure the driving effect of all the display pixels.

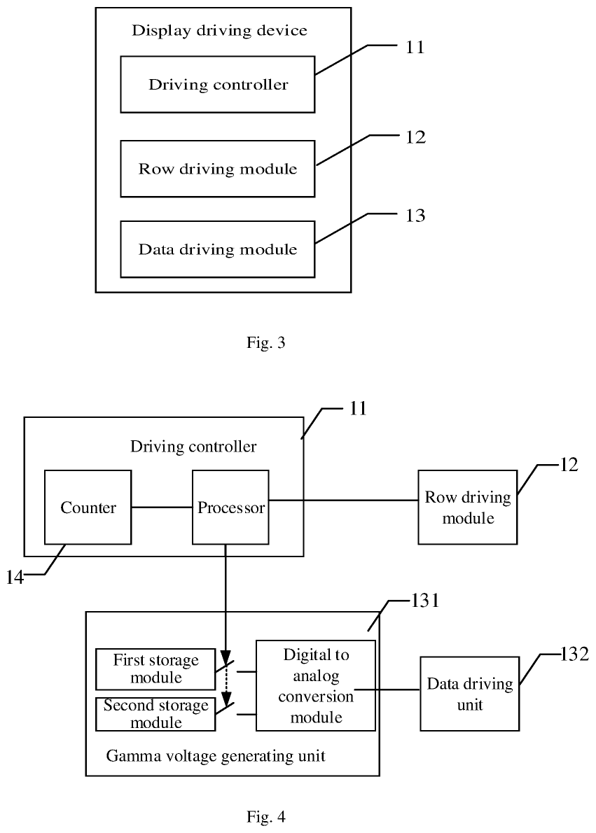

Referring FIG. 3, FIG. 3 is a view of functional modules of a display driving device according to an embodiment of the present application. The display driving device includes:

a row driving module 12 periodically outputting a row driving signal to drive display pixels of each row, and obtaining a position of the row driven by the current row driving signal;

a driving controller 11 outputting a driving control signal, controlling the row driving module 12 to perform scanning, and obtaining a position of a row driven by the current row driving signal, and determining whether a row driven by the current row driving signal is located at a near end or a far end;

a data driving module 13 generating a first data signal when the row driven by the current row driving signal is located at a near end, and outputting a second data signal when the row driven by the current row driving signal is located at a far end, according to the position determination result of the driving controller; wherein among the display pixels of all the rows, the display pixel away from a signal output source of the row driving signal with a predetermined number of rows is the near-end, and the display pixel of the remaining rows is the far end.

In an embodiment of the present application, the driving controller 11 controls the row driving module 12 to output driving signals row by row or interlaced to drive display pixels of each row. At the same time, the driving controller determines whether the row driven by the current row driving signal is located at the near end or the far end, and controls the data driving module 13 to output the corresponding data signal, thereby improving the problem of the difference in the charging effect of the display pixels at the near end and far end, and achieving a uniform display effect.

Referring FIG. 4, FIG. 4 is a view of functional modules of a display driving device according to another embodiment of the present application. In a certain embodiment of the present application, the above driving controller 11 includes a counter 14 and a processor MCU, counting once each time the row driving module 12 completes driving of one row of display pixels; the processor obtains a position of a row driven by the current row driving signal according to the counting result.

Specifically, counting is performed by configuring a counter 14 for driving the display pixels each time one row is completed. According to the count value of the counter, the processor may determine the position of the row driven by the driving signal of the current row, and generate a driving control signal to control the data driving module 13 to output a corresponding data signal. Specifically, the processor may determine the position of the row driven by the driving signal of the current row according to the count value of the counter 14, and generates a first control signal when the row driven by the current row driving signal is located at a near end, and generates a second control signal when the row driven by the current row driving signal is located at a far end. In an embodiment of the present application, the counter technology is relatively simple, so it is easy to increase the structure of the counter in the display driving device.

The above display driving device controls the row driving module 12 and the data driving module 13 to output signals through the driving controller 11 to output signals, thereby realizing display control of the display pixels. Moreover, by disposing the counter 14 in the driving controller 11, by the control of the driving controller 11, the purpose of controlling the data driving module 13 to output signals according to the row position may be directly achieved. In addition, if the counter structure already exists in the display driving device, the original structure of the display driving device may also be utilized, thereby saving hardware costs.

Further, the above first control signal and the second control signal may be implemented by using an one-bit status code, for example, if the status code is a low level signal, it is the first control signal; if the status code is a high level signal, it is the second control signal. Of course, it may also be configured that the status code is a high level signal, which is the first control signal; and the status code is a low level signal, which is the second control signal.

In a certain embodiment of the present application, the above data driving module 13 includes:

a gamma voltage generating unit 131 generating a first gamma signal when the row driven by the current row driving signal is located at a near end, and generating a second gamma signal when the row driven by the current row driving signal is located at a far end;

a data driving unit 132 outputting a corresponding data signal according to the gamma signal generated by the gamma voltage generating unit.

In the above gamma voltage generating unit 131, two storage modules may be provided to store different values. For example, the first storage module bank_A is used to store the first gamma voltage value, and the second storage module bank_B is used to store the second gamma voltage value. When ban_A is selected, the corresponding first gamma voltage is output to the digital to analog conversion module to generate the first gamma signal. When bank_B is selected, the corresponding second gamma voltage is output to the digital to analog conversion module to generate the second gamma signal. The data driving unit 132 outputs a corresponding data signal according to the gamma signal generated by the gamma voltage generating unit 131.

Further, the gamma voltage generating unit 131 outputs a corresponding stored value according to the first control signal and the second control signal outputted by the driving controller 11, thereby generating a corresponding gamma signal. For example, the gamma voltage generating unit 131 outputs the value of bank_A according to the first control signal, thereby causing the gamma voltage generating unit 131 to generate the first gamma signal; the gamma voltage generating unit 131 outputs the value of bank_B according to the second control signal, thereby causing the gamma voltage generating unit 131 to generate the second gamma signal.

In a certain embodiment of the present application, the above driving controller 11 controls the row driving module 12 to provide signals sequentially in a row-by-row or in reverse-sequence, row-by-row or interlaced manner to drive the display pixels row by row or in interlaced manner.

When the processor sequentially provides a driving signal row by row to drive the display pixel row by row, the processor determines, according to the count result of the counter, that when the count value is greater than a predetermined number of rows, the row driven by the current row driving signal is located at the far end, otherwise determines that the row driven by the current row driving signal is located at the near end; or

when the processor provides a driving signal row by row to drive the display pixel row by row in reverse order, the processor determines, according to the count result of the counter, that when the count value is less than or equal to a predetermined number of rows, the row driven by the current row driving signal is located at the far end, otherwise determines that the row driven by the current row driving signal is located at the near end.

When the processor provides a driving signal in interlaced manner to drive the display pixel in interlaced manner, the processor determines, according to the count result of the counter, that when the count value is within a predetermined range, the row driven by the current row driving signal is located at the far end, otherwise determines that the row driven by the current row driving signal is located at the near end.

When the processor controls the row driving module 12 to drive the display pixels row by row, a first predetermined threshold is determined. The first predetermined threshold is a predetermined number of rows when the near-end and far-end are determined. Taking 1000 rows of display pixels as an example, it is assumed that the first to 500th rows of display pixels close to the data driving module 13 are used as the display pixels at the near end, and the remaining display pixels are used as the display pixels at the far end. Therefore, when the count value is greater than 500, it is determined that the current row driving signal has been driven to the display pixel at the far end; when the count value is less than or equal to 500, it is determined that the current row driving signal still drives the display pixels at the near end.

Similarly, when the processor controls the row driving module 12 to drive the display pixels in reverse order row by row, according to the count result of the counter, the processor determines that the row driven by the current row driving signal is located at the near end when the count value is greater than the first predetermined threshold; determining that the row driven by the current row driving signal is located at the far end when the count value is less than or equal to the first predetermined threshold.

When the processor controls the row driving module 12 to drive the display pixels in interlaced manner, a second predetermined threshold is determined. The second predetermined threshold is ½ of the predetermined number of rows when the near-end and far-end are determined. Taking 1000 rows of display pixels as an example, it is assumed that the first to 500th rows of display pixels close to the data driving module 13 are used as the display pixels at the near end, and the remaining display pixels are used as the display pixels at the far end. Therefore, when the count value is between 250-500 and 750-1000, it is determined that the current row driving signal has been driven to the display pixel at the far end; when the count value is between 1-250 (not included) and 501-750 (not included), it is determined that the current row driving signal still drives the display pixels at the near end.

Based on the above embodiments, other embodiments of the present application may be modified. For example, the display pixels of all the rows are divided into three or more regions, and different data signals are output corresponding to the plurality of regions to ensure the driving effect of all the display pixels.

It should be noted that in the claims, any reference signs placed between parentheses should not be construed as a limitation. The word “comprising” does not exclude the presence of the components or steps that are not recited in the claims. The word “a” or “one” before the components does not exclude the presence of a plurality of such components. The present application may be implemented by means of hardware comprising several distinct components, and by means of a suitably programmed computer. In the unit claims enumerating several devices, several of these devices may be embodied by the same hardware item. The use of the words “first”, “second”, and “third” does not indicate any order. These words may be interpreted as names.

Although optional embodiments of the present application are already described, once those skilled in the art understand basic creative concept, they can make additional modification and alteration for these embodiments. Therefore, the appended claim is intended to comprise optional embodiments and various changes and modifications within the scope of the present application.

It will be apparent to those skilled in the art that various modifications and variations of the present application may be made without departing from the spirit or scope of the application. If these various modifications and variations of the present application belong to the scope of the claim and equivalent technical scope, the present application is intended to comprise these modifications and variations.

What is claimed is:

1. A display driving method, wherein the display driving method comprises steps of:
periodically outputting a row driving signal to drive display pixels of each row;
obtaining a position of a row driven by the current row driving signal, and determining whether a row driven by the current row driving signal is located at a near end or a far end;
outputting a first data signal if the row driven by the current row driving signal is located at the near end; and,
outputting a second data signal if the row driven by the current row driving signal is located at the far end;
wherein among the display pixels of all the rows, the display pixel away from a signal output source of the row driving signal with a predetermined number of rows is the near-end, and the display pixel of the remaining rows is the far end.

2. The display driving method according to claim 1, wherein the display driving method further comprises:
counting each time a row of display pixels is driven to obtain a position of a row driven by the current row driving signal according to the counting result.

3. The display driving method according to claim 2, wherein when the row driving signal is sequentially provided row by row, the step of obtaining a position of a row driven by the current row driving signal includes:
determining that the row driven by the current row driving signal is located at the far end when the count value is greater than a predetermined number of rows; determining that the row driven by the current row driving signal is located at the near end when the count value is less than or equal to the predetermined number of rows.

4. The display driving method according to claim 2, wherein when the row driving signal is provided row by row in reverse order, the step of obtaining a position of a row driven by the current row driving signal includes:
determining that the row of the signal driven by the current row driving signal is located at the near end when the count value is greater than a predetermined number of rows; determining that the row of the signal driven by the current row driving signal is located at the far end when the count value is less than or equal to the predetermined number of rows.

5. The display driving method according to claim 1, wherein the predetermined number of rows is configured according to a predetermined ratio of the number of rows of all display pixels.

6. The display driving method according to claim 5, wherein the predetermined ratio is 50%.

7. The display driving method according to claim 1, wherein the amplitude of the first data signal is less than the amplitude of the second data signal.

8. A display driving device, wherein the display driving device comprises:
a row driving module periodically outputting a row driving signal to drive display pixels of each row;
a driving controller outputting a driving control signal, controlling the row driving module to perform scanning, and obtaining a position of a row driven by the current row driving signal, and determining whether a row driven by the current row driving signal is located at a near end or a far end;
a data driving module generating a first data signal when the row driven by the current row driving signal is located at a near end, and outputting a second data signal when the row driven by the current row driving signal is located at a far end, according to the position determination result of the driving controller;
wherein among the display pixels of all the rows, the display pixel away from a signal output source of the row driving signal with a predetermined number of rows is the near-end, and the display pixel of the remaining rows is the far end.

9. The display driving device according to claim 8, wherein the driving controller includes a counter and a processor, counting once each time the row driving module completes driving of one row of display pixels; the processor determines a position of a row driven by the current row driving signal according to the counting result, and generates a corresponding driving control signal to control the data driving module to output a corresponding data signal.

10. The display driving device according to claim 9, wherein the driving control signal is a one-bit status code.

11. The display driving device according to claim 8, wherein the data driving module includes:
a gamma voltage generating unit generating a first gamma signal when the row driven by the current row driving signal is located at a near end, and generating a second gamma signal when the row driven by the current row driving signal is located at a far end;
a data driving unit outputting a corresponding data signal according to the gamma signal generated by the gamma voltage generating unit.

12. The display driving device according to claim 11, wherein the amplitude of the first data signal is less than the amplitude of the second data signal.

13. The display driving device according to claim 9, wherein when the processor sequentially provides a driving signal row by row to drive the display pixel row by row, the processor determines, according to the count result of the counter, that when the count value is greater than a predetermined number of rows, the row driven by the current row driving signal is located at the far end, otherwise determines that the row driven by the current row driving signal is located at the near end.

14. The display driving device according to claim 9, wherein when the processor provides a driving signal row by row in reverse order, to drive the display pixel row by row, the processor determines, according to the count result of the counter, that when the count value is less than or equal to a predetermined number of rows, the row driven by the current row driving signal is located at the far end, otherwise determines that the row driven by the current row driving signal is located at the near end.

15. The display driving device according to claim 8, wherein the predetermined number of rows is configured according to a predetermined ratio of the number of rows of all display pixels.

16. The display driving device according to claim 15, wherein the predetermined ratio is 50%.

17. A display device, wherein the display device comprises a display pixel and a display driving device that drives the display pixel to illuminate, the display driving device including:
a row driving module periodically outputting a row driving signal to drive display pixels of each row;
a driving controller outputting a driving control signal, controlling the row driving module to perform scanning, and obtaining a position of a row driven by the current row driving signal, and determining whether a row driven by the current row driving signal is located at a near end or a far end;
a data driving module generating a first data signal when the row driven by the current row driving signal is located at a near end, and outputting a second data signal when the row driven by the current row driving signal is located at a far end, according to the position determination result of the driving controller;
wherein among the display pixels of all the rows, the display pixel away from a signal output source of the row driving signal with a predetermined number of rows is the near-end, and the display pixel of the remaining rows is the far end.

18. The display device according to claim 17, wherein the driving controller includes a counter and a processor, counting once each time the row driving module completes driving of one row of display pixels; the processor determines a position of a row driven by the current row driving signal according to the counting result, and generates a corresponding driving control signal to control the data driving module to output a corresponding data signal.

19. The display device according to claim 18, wherein the driving control signal is a one-bit status code.

20. The display device according to claim 17, wherein the data driving module includes:
a gamma voltage generating unit generating a first gamma signal when the row driven by the current row driving signal is located at a near end, and generating a second gamma signal when the row driven by the current row driving signal is located at a far end;
a data driving unit outputting a corresponding data signal according to the gamma signal generated by the gamma voltage generating unit.
